(19) United States
(12) Patent Application Publication
(10) Pub. No.: US 2026/0002972 A1
(43) Pub. Date: Jan. 1, 2026

(54) FINGERPRINTING CHIPLETS THROUGH POWER DISTRIBUTION NETWORK

(71) Applicant: THE MITRE CORPORATION, McLean, VA (US)

(72) Inventors: Nimit NGUANSIRI, Wilmington, MA (US); Rachel BAINBRIDGE, Concord, MA (US); Victor Simon MERCOLA, Cambridge, MA (US)

(73) Assignee: THE MITRE CORPORATION, McLean, VA (US)

(21) Appl. No.: 18/760,742

(22) Filed: Jul. 1, 2024

(51) Int. Cl. G01R 31/08; G06F 21/45

(52) U.S. Cl. CPC G01R 31/086; G06F 21/45

(57) ABSTRACT

The present disclosure describes a heterogeneous integration (HI) system including an interposer and a plurality of dies coupled by the interposer. The plurality of dies include a die, a transmitter die, and a receiver die. The transmitter die is configured to provide a test signal to the die to generate a perturbation in a power distribution network (PDN) of the HI system. The receiver die is configured to measure a response signal in response to the perturbation in the PDN and to determine an authenticity of the die based on a machine learning classification algorithm applied on the response signal. The disclosure also describes a method of testing the authenticity of the die and a method of training the machine learning classification algorithm.

### TECHNICAL FIELD

This disclosure is generally directed to using power distribution networks of chiplets to verify system integrity.

### BACKGROUND

Chip manufacturers normally rely on Moore's Law to create complex integrated systems on a single silicon die. More recently, with increasing design complexity, smaller nodes and a shift to systems-on-chip (SoCs) architectures, manufacturers are beginning to run into the limits of Moore's law. Large single, or monolithic, designs are becoming more impractical as the physical size of the integrated circuits increase which leads to decreasing yields of manufacturing such designs. Accordingly, manufacturers have explored systems-on-chip (SoCs) architectures for these increasingly complicated integrated systems. Shifting to SoC architectures involving heterogeneous type dies (as opposed to monolithic dies) presents its own challenges: communications between the multiple components on the heterogeneous die may be more susceptible to security attacks such as probing and die swap at the interconnects between these components.

### SUMMARY

Provided herein are system, apparatus, article of manufacture, method and/or computer program product embodiments, and/or combinations and sub-combinations thereof for generating and testing signatures of power distribution networks (PDNs) for components on SoCs or chiplets to verify system integrity.

An example embodiment of the present disclosure can be a multi-chiplet system including a first die, a second die, and a third die on a substrate and coupled with each other via an interposer on the substrate. The second die is configured to provide a test signal to a PDN of the multi-chiplet system to test a condition of an authenticity of the first die. The third die is configured to receive a response signal in respond to the test signal. The third die is further configured to use a machine learning classification algorithm to determine the authenticity of the first die according to its response signal.

### BRIEF DESCRIPTION OF THE DRAWINGS

Aspects of the present disclosure are best understood from the following detailed description when read with the accompanying figures. It is noted that, in accordance with the common practice in the industry, various features are not drawn to scale. In fact, the dimensions of the various features may be arbitrarily increased or reduced for clarity of illustration and discussion.

FIG. 1 illustrates a multi-chiplet system, in accordance with some embodiments.

FIG. 2 illustrates a close-up of a multi-chiplet system, in accordance with some embodiments.

FIG. 3 is a flowchart of a method for verifying the authenticity of a chiplet, in accordance with some embodiments.

FIG. 4 illustrates a diagram of a method for verifying the authenticity of a chiplet, in accordance with some embodiments.

FIG. 5 is a flowchart of a method for training a machine learning classification algorithm for verifying the authenticity of a chiplet, in accordance with some embodiments.

FIG. 6 illustrates an example computer system useful for implementing various embodiments, in accordance with some embodiments.

Illustrative embodiments will now be described with reference to the accompanying drawings. In the drawings, like reference numerals generally indicate identical, functionally similar, and/or structurally similar elements.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over a second feature in the description that follows may include embodiments in which the first and second features are formed in direct contact, and may also include embodiments in which additional features may be formed between the first and second features, such that the first and second features may not be in direct contact. As used herein, the formation of a first feature on a second feature means the first feature is formed in direct contact with the second feature. In addition, the present disclosure may repeat reference numerals and/or letters in the various examples. This repetition does not in itself dictate a relationship between the various embodiments and/or configurations discussed.

Further, spatially relative terms, such as “beneath,” “below,” “lower,” “above,” “upper,” and the like, may be used herein for ease of description to describe one element or feature's relationship to other element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

It is noted that references in the specification to “one embodiment,” “an embodiment,” “an example embodiment,” “exemplary,” etc., indicate that the embodiment described may include a particular feature, structure, or characteristic, but every embodiment may not necessarily include the particular feature, structure, or characteristic. Moreover, such phrases do not necessarily refer to the same embodiment. Furthermore, when a particular feature, structure or characteristic is described in connection with an embodiment, it would be within the knowledge of one skilled in the art to effect such feature, structure, or characteristic in connection with other embodiments whether or not explicitly described.

It is to be understood that the phraseology or terminology herein is for the purpose of description and not of limitation, such that the terminology or phraseology of the present specification is to be interpreted by those skilled in relevant art(s) in light of the teachings herein.

In some embodiments, the terms “about” and “substantially” can indicate a value of a given quantity that varies within 5% of the value (e.g., +1%, +2%, +3%, +4%, +5% of the value). These values are merely examples and are not intended to be limiting. The terms “about” and “substantially” can refer to a percentage of the values as interpreted by those skilled in relevant art(s) in light of the teachings herein.

Provided herein are system, apparatus, article of manufacture, method and/or computer program product embodiments, and/or combinations and sub-combinations thereof for generating and testing signatures of power distribution networks (PDNs) for components on SoCs or multi-chiplet systems to verify integrities of the components.

Chiplets overcome the limitations of manufacturing increasingly complex integrated systems on monolithic dies. Chiplets are formed by partitioning a larger chip design into multiple smaller components. Chiplets are smaller dies that may be separately fabricated with standardized interfaces, which may then be integrated into a larger system by assembly on a passive silicon interposer or a bridge that may connect the chiplets to each other.

Heterogeneous die SoCs (with multiple chiplets) face different security risks than single die SoCs. A single manufacturing vendor has more control of on-chip components that are placed on the die so security threats faced by single die SoCs generally involve attacks from outside of the die. In contrast, heterogeneous dies rely on chiplets that may be manufactured by different entities. Because of the different entities, communications between chiplets are provided via standardized interfaces, or interconnects, which allow the chiplets to be integrated onto the SoC in various configurations. Chiplet configuration therefore provides flexibility in creating SoCs where chiplets may be interchanged on the die for improved features and performance. However, this flexibility, provided via the standardized interconnects, leads to increased security exposure. For example, die swapping, interface tampering, and man-in-the-middle attacks are made possible and easier to execute with the distinct segregation of the dies. One may not be able to assume that other chiplets on the die that are receiving or transmitting signals to the chiplet are honest and not nefarious actors posing as a trusted assembly.

A PDN of a heterogeneous die SoC is a network providing sufficient and regulated power to each of the chiplets of the heterogeneous die SoC. The PDN is the most inter-connected component in the heterogeneous die SoC, and the only physical network that touches each chiplet of the heterogeneous die SoC. The PDN is extremely difficult to model, design, and characterize across all potential conditions that the heterogeneous die SoC can experience. For example, the chiplets of the heterogeneous die SoC can be functioning under direct current (DC) and/or alternating current (AC) power supply and coupled with instantaneously varying external loads. The chiplets can also have different sensitivities to environment factors (such as temperature variation). On one hand, the complexity of the PDN gives opportunities to harvest and characterize manufacturing variations. For example, replacing a chiplet with another chiplet with the same design (or even within the same production batch) can alter the PDN due to inevitable variations of the two chiplets during their manufacture process. On the other hand, using the PDN as a fingerprint to detect changes indicating a tamper event of the heterogeneous die SoC is also challenging, due to the complexity of the PDN.

To overcome the challenges mentioned above, the embodiments described herein are directed to a multi-chiplet system and a method of operating the multi-chiplet system. The multi-chiplet system can include a chiplet, a transmitter die, and a receiver die coupled by an interposer. The transmitter die and the receiver die can examine a condition of authenticity of the chiplet (i.e., determine whether the chiplet is authentic or compromised). In some embodiments, the transmitter die can provide a test signal to the chiplet to perturb a PDN of the multi-chiplet system, and the receiver die can receive a response signal (for example, a delayed signal of the test signal) in response to the perturbation of the PDN by the test signal. In some embodiments, a machine learning classification algorithm can be used to analyze the response signal and generate a signature of the response signal to determine the condition of the authenticity of the chiplet. In some embodiments, the method can include operating the multi-chiplet system to determine the condition of the authenticity of the chiplet. In some embodiments, the method can include training the machine learning classification algorithm using a training dataset about response signals of a number of chiplets.

In the present disclosure, an exemplary multi-chiplet system comprises at least three chiplets connected to each other via an interposer. The chiplets can be field-programmable gate arrays (FPGAs). The interposer may comprise a plurality of interconnect traces, or wires, through which the chiplets may transmit and receive signals from other chiplets. The multi-chiplet system may further include a controller in communication with the chiplets via the interposer and that may be configured to facilitate the determination of delay in signals transmitted between the chiplets.

In some embodiments, for some multi-die FPGAs when implemented as Xilinx FPGAs, stacked silicon interconnect (SSI) may be used. SSI combines multiple FPGA dies into a single device using microbump connections to a shared silicon interposer. FPGA chiplet dies may include super logic regions (SLRs) and may have low latency connections known as super long lines (SLLs) that connect adjacent edges of neighboring SLRs. Through-silicon vias (TSV) through the interposer may connect down to the package substrate. FPGAs may provide users with control over clocking and the reconfigurable logic allows for transmitting arbitrary known patterns on demand across chiplet boundaries. FPGAs in the present disclosure are not limited to SSI and Xilinx FPGAs. Each FPGA can be configured for a functionality at a time and reconfigured for another functionality at another time. The configuration of an FPGA is also referred to as a ‘build’ of the FPGA. In this disclosure, a condition of an authenticity of a build of an FPGA can also be examined in the multi-chiplet system. The chiplet inter-die interface may be composed of one or more wires through an interposer. The interposer itself may be an electrical interface routing between one socket or connection to another socket or connection. The interposer may spread a connection to a wider pitch or to reroute a connection to a different connection.

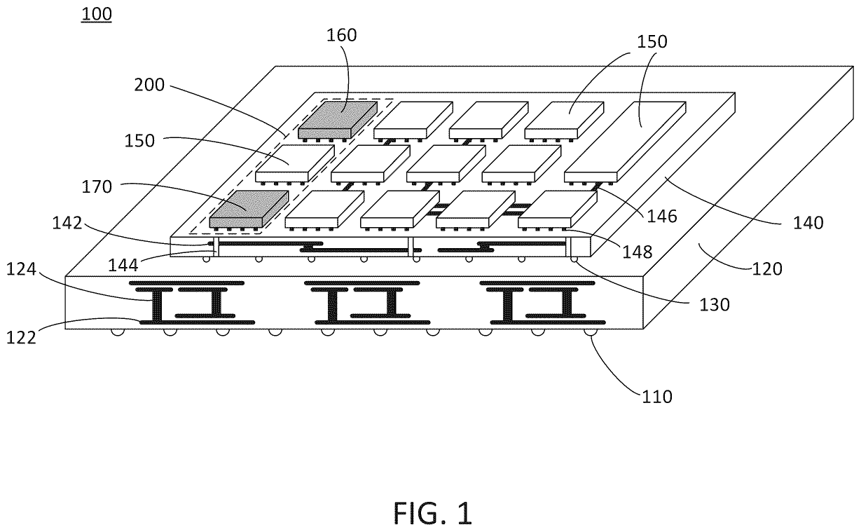

FIG. 1 illustrates a multi-chiplet system 100, according to some embodiments. For example, multi-chiplet system 100 can be a heterogeneous integration (HI) system. Multi-chiplet system 100 can include a package substrate 120 with solder balls 110 disposed at a bottom surface of package substrate 120. On the package substrate 120 is C4 bumps 130. Package substrate 120 can include electrical interconnects embedded in package substrate 120, such as metal lines 122 and metal vias 124.

Multi-chiplet system 100 can further include a silicon interposer 140 disposed on a top surface of package substrate 120. In some embodiments, silicon interposer 140 and package substrate 120 can be electrically coupled by C4 bumps 130 disposed between them. In some embodiments, silicon interposer 140 can include electrical interconnects embedded in silicon interposer 140 or disposed on a top surface of silicon interposer 140, such as metal lines 142, through silicon vias (TSVs) 144, and surface lines 146.

Multi-chiplet system 100 can further include a number of chiplets 150 disposed on silicon interposer 140, which can electrically couple with chiplets 150 via pads 148. In some embodiments, pads 148 can include microbumps. In some embodiments, chiplets 150 can be the same kind of chiplet performing the same function. In some embodiments, chiplets 150 can include different kind of chiplets performing different functions. Each of chiplets 150 can be electrically coupled to other chiplets 150 via the electrical interconnects in silicon interposer 140.

Multi-chiplet system 100 can further include a transmitter (TX) die 160 and a receiver (RX) die 170 disposed on silicon interposer 140 and electrically coupled with silicon interposer 140 via pads 148. TX die 160 and RX die 170 can also be electrically coupled with chiplets 150 via the electrical interconnects in silicon interposer 140. FIG. 1 shows an embodiment with TX die 160 and RX die 170 disposed at corners of silicon interposer 140. However, it is understood for a person of skill in the art that TX die 160 and RX die 170 can be disposed at any other suitable positions on silicon interposer 140.

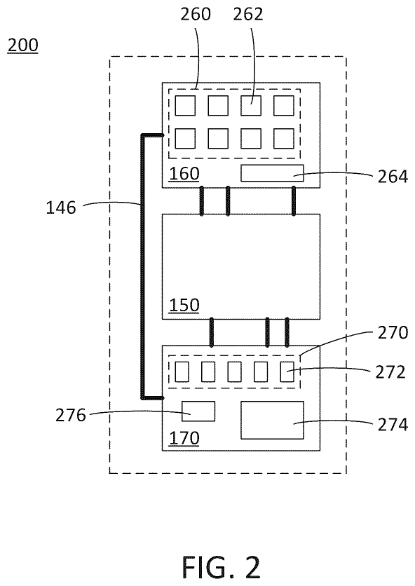

FIG. 2 illustrates a close-up 200 of multi-chiplet system 100 in FIG. 1, according to some embodiments. The description of elements in FIG. 1 with the same annotations applies to FIG. 2, unless mentioned otherwise. Note that FIG. 2 shows an embodiment with close-up 200 including TX die 160, RX die 170, and chiplet 150 disposed in between TX die 160 and RX die 170, and the electrical interconnects (e.g., surface lines 146) coupling TX die 160, chiplet 150, and RX die 170. However, it is understandable to a person of skill in the art that chiplet 150 of close-up 200 as shown in FIG. 2 can be replaced by any other chiplets 150 as shown in FIG. 1.

Referring to FIG. 2, in some embodiments, TX die 160 can include an array of ring oscillators (ROs) 260 and a control unit 264 coupled to array of ROs 260. In some embodiments, array of ROs 260 can include a number of ROs, which can be divided into groups of ROs 262. In some embodiments, the number of ROs included in array of ROs 260 can be between about 1,000 and about 100,000. For example, the number of ROs included in array of ROs 260 can be about 1,000, about 2,000, about 5,000, about 10,000, about 20,000, about 50,000, and about 100,000. In some embodiments, the number of ROs included in array of ROs 260 can be between about 5,000 and about 20,000. In one embodiment, the number of ROs included in array of ROs 260 can be about 11,700. In some embodiments, each of groups of ROs 262 can include the same amount of ROs. In some embodiments, each of groups of ROs 262 can include different amount of ROs. In some embodiments, the number of ROs included in each group of ROs 262 can be between about 100 and about 10,000. For example, the number of ROs included in each group of ROs 262 can be about 780. In some embodiments, the number of groups of ROs 262 included in array of ROs 260 can be between about 3 and about 20. For example, the number of groups of ROs 262 included in array of ROs 260 can be about 3, about 5, about 8, about 10, about 12, about 15, about 18, and about 20. In some embodiments, the number of groups of ROs 262 included in array of ROs 260 can be greater than about 20.

A ring oscillator (RO) can include a single inverter feeding back onto itself, or a series of an odd number of inverters strung together in a loop. The function of array of ROs 260 is to provide a test signal to chiplet 150 via silicon interposer 140, as shown in FIG. 2. In some embodiments, the test signal can perturb the PDN of the multi-chiplet system 100 with one or more of chiplet 150 activated to be tested. The test signal can be viewed as a noise injected into the multi-chiplet system 100 and can interfere with the power distributed to the chiplets through the PDN of multi-chiplet system 100, such that the distribution of the power is perturbed and deviate from a regular state when the test signal is absent. In some embodiments, the test signal can be a periodic signal with a chosen frequency, phase, amplitude, and/or duration. For example, the test signal can be a sinusoidal wave, a square wave, and/or a triangular wave. In some embodiments, the test signal can be an impulse (e.g., step impulse, Gaussian impulse, square impulse, decaying impulse, etc). In some embodiments, the test signal can be a noise signal, such as a white noise signal or any other noise signals with chosen spectra. In some embodiments, each group of ROs 262 can contribute a component for the test signal. For example, each group of ROs 262 can contribute a Fourier component for the test signal. The test signal can be customized by configuring parameters of groups of ROs 262 that determine the components contributing for a spectrum of the test signal. For example, each group of ROs 262 can be configured by a number of parameters that determine a frequency of the component contributing to the test signal. In some embodiments, each groups of ROs 262 can be configured by about 2 to about 5 parameters.

In some embodiments, control unit 264 can be an electrical circuit for configuring array of ROs 260 to provide the test signal. For example, control unit 264 can provide the parameters to groups of ROs 262 that determine the components contributing to the test signal. In some embodiments, control unit 264 can communicate with external circuits via silicon interposer 140. For example, control unit 264 can receive external commands to configure array of ROs 260 to provide the test signal. In some embodiments, control unit 264 can receive the external commands to activate chiplet 150 (or any other chiplets 150 in multi-chiplet system 100 as shown in FIG. 1) to be tested. In some embodiments, control unit 264 can also provide information about the test signal to RX die 170, such as the time when the test signal is sent to chiplet 150, such that RX die 170 can determine a time delay and/or an amplitude of the test signal by chiplet 150.

Referring to FIG. 2, in some embodiments, RX die 170 can include an array of time-to-digital converters (TDCs) 270. In some embodiments, array of TDCs 270 can include a number of TDCs 272. In some embodiments, the number of TDCs 272 included in array of TDCs 270 can be between about 3 and about 20. For example, the number of TDCs 272 included in array of TDCs 270 can be about 3, about 5, about 8, about 10, about 15, and about 20. In some embodiments, the number of TDCs 272 included in array of TDCs 270 can be greater than about 20.

A TDC is an FPGA device which can measure time delays and/or amplitudes and convert the time delays and/or amplitudes into digital readings. In some embodiments, the test signal provided by TX die 160 to chiplet 150 can generate a perturbation in the PDN of multi-chiplet system 100, such that TDC 272 in array of TDCs 270 can pick up a response signal due to the perturbation in the PDN. In some embodiments, TDC 272 in array of TDCs 270 can measure the test signal, such as a time delay of the test signal (e.g., a duration between sending the test signal from TX die 160 and receiving the response signal by TDC 272) and/or an amplitude of the test signal (e.g., a voltage amplitude or a current amplitude of the test signal). In some embodiments, the time delay and/or the amplitude measured by a specific TDC 272 in array of TDCs 270 can uniquely depend on a variety of factors such as the test signal configured by TX 160, the PDN of multi-chiplet system 100 with chiplet 150 activated to be tested, and the physical location of the specific TDC 272 in RX die 170. In some embodiments, given a specific test signal, time delays and/or amplitudes measured by different TDC 272 in RX die 170 can be different, due to the different physical locations of each TDC 272. For a specific test signal, array of TDCs 270 can provide data of time delays and/or amplitudes measured by the TDCs 272. As a measure of the perturbation of the PDN of multi-chiplet system 100 with chiplet 150 activated to be tested, the data of time delays and/or amplitudes can be a unique signature of chiplet 150 as a member of multi-chiplet system 100. The data of time delays and/or amplitudes can also be referred to as a fingerprint of chiplet 150. In some embodiments, if chiplet 150 is compromised (e.g., counterfeits/swapped, tampered/probed without authorization, and/or implanted with Trojans), the data of time delays and/or amplitudes provided by array of TDCs 270 in response to the specific test signal provided by TX die 160 can be altered from the data of time delays and/or amplitudes measured when chiplet 150 is uncompromised or authentic. In some embodiments, whether chiplet 150 is authentic or compromised can be determined by analyzing the data of time delays and/or amplitudes provided by array of TDCs 270 in response to the test signal provided by TX die 160. In some embodiments, the analysis of the data of time delays and/or amplitudes can be performed using a machine learning classification algorithm, such as a principal component analysis (PCA) algorithm.

Referring to FIG. 2, in some embodiments, RX die 170 can further include a storage unit 276 configured to store an authentic data of time delays and/or amplitudes about chiplet 150. Storage unit 276 can be a memory, such as a read-only memory (ROM). The authentic data of time delays and/or amplitudes can also be referred to as a standard fingerprint (or golden fingerprint) of chiplet 150. In some embodiments, the standard fingerprint can be generated after the manufacturing of multi-chiplet system 100 and before multi-chiplet system 100 is shipped outside the manufactory (e.g., at a final manufacturing stage), so as to ensure the authenticity of the standard fingerprint. In some embodiments, the standard fingerprint can be generated by a similar process as the data of time delays and/or amplitudes as described above. For example, the standard fingerprint can be generated by configuring groups of ROs 262 in TX die 160 to provide the test signal to chiplet 150 and measure the response signals by TDCs 270 in RX die 170. The standard fingerprint for chiplet 150 can then be stored in storage unit 276. In some embodiments, standard fingerprints for all chiplets 150 of multi-chiplet system 100 can be generated and stored in storage unit 276.

Referring to FIG. 2, in some embodiments, RX die 170 can further include a processing unit 274, which can be an electric circuit for processing the data of time delays and/or amplitudes provided by the TDCs 270. In some embodiments, processing unit 274 can perform an analysis of the data of time delays and/or amplitudes using the machine learning classification algorithm, such as the PCA algorithm to process the data of time delays and/or amplitudes of chiplet 150. In some embodiments, if chiplet 150 is compromised, the machine learning classification algorithm can provide information about how chiplet 150 is compromised (e.g., counterfeits/swapped, tampered/probed without authorization, and/or implanted with Trojans). In some embodiments, processing unit 274 can preprocess the data of time delays and/or amplitudes before analyzing the data of time delays and/or amplitude by the machine learning classification algorithm. For example, processing unit 274 can conduct averaging of the data of time delays and/or amplitudes, truncation or augmentation to the data of time delays and/or amplitudes, Fourier transformation on the data of time delays and/or amplitudes, and/or filtering the data of time delays and/or amplitudes. In some embodiments, after analyzing the data of time delays and/or amplitudes, processing unit 274 can provide a fingerprint of chiplet 150 and compare it with the standard fingerprint of chiplet 150 stored in storage unit 276 and determine the authenticity of chiplet 150 according to a deviation of the fingerprint from the standard fingerprint. For example, if the deviation of the fingerprint from the standard fingerprint is beyond or not greater a predetermined threshold range, chiplet 150 can be determined as compromised or authentic, respectively. In some embodiments, based on the analysis of the data of time delays and/or amplitudes and the comparison between the fingerprint and the standard fingerprint, processing unit 274 can provide an information (e.g., in a report) of the information about the authenticity of chiplet 150. In some embodiments, processing unit 274 can communicate with external circuits via silicon interposer 140. For example, processing unit 274 can receive external commands to activate chiplet 150 (or any other chiplets 150 in multi-chiplet system as shown in FIG. 1) to be tested. In some embodiments, processing unit 274 can transmit the data of time delays and/or amplitudes, the standard fingerprint of chiplet 150, and/or the information about the authenticity of chiplet 150 to the external circuits. In some embodiments, processing unit 274 can receive information about the test signal (such as the time when the test signal is sent to chiplet 150) directly provided from RX die 160, such that TDCs 272 can determine the time delays and/or amplitudes of the test signal by chiplet 150.

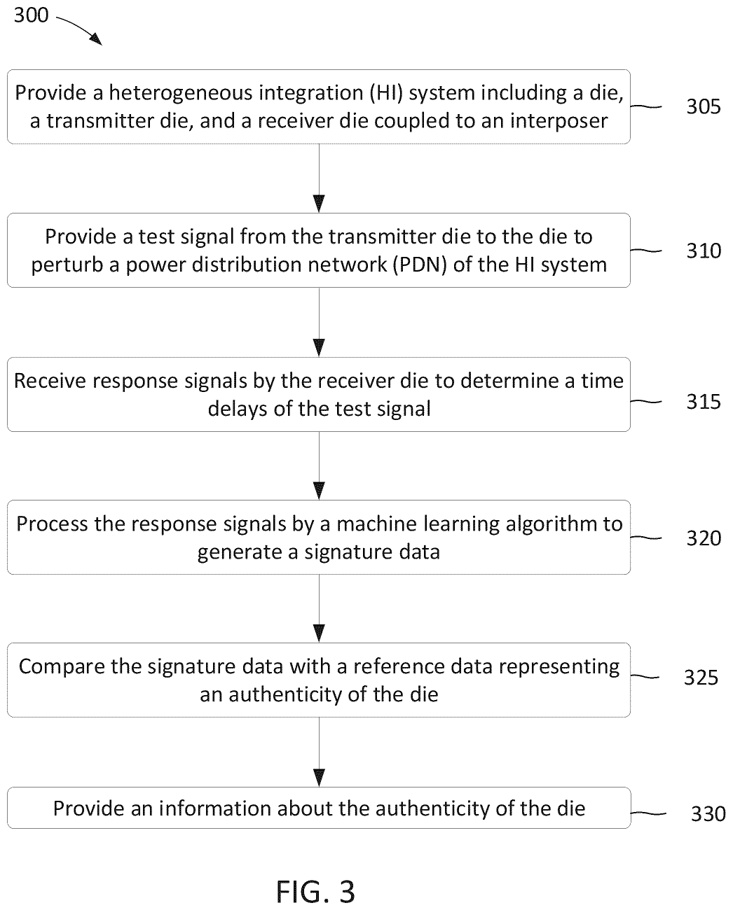

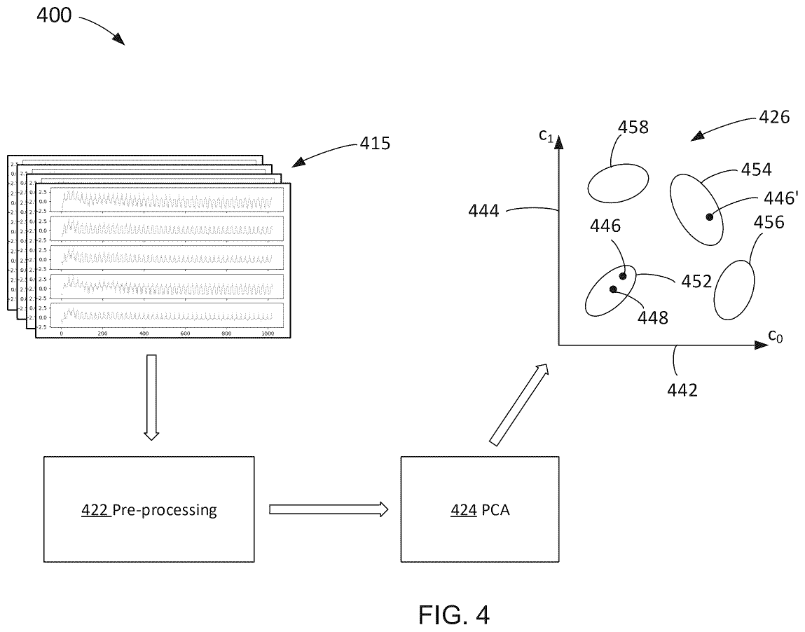

According to some embodiments, FIG. 3 illustrates a flowchart of a method 300 for examining an authenticity of a chiplet in an HI system. This disclosure is not limited to this operational description and additional operations may be performed. Other operations can be performed between the various operations of method 300 and are omitted merely for clarity. Moreover, not all operations may be needed to perform the disclosure provided herein. Additionally, some of the operations may be performed simultaneously, or in a different order than the ones shown in FIG. 3. In some embodiments, one or more other operations may be performed in addition to or in place of the presently described operations. For illustrative purposes, method 300 is described with reference to multi-chiplet system 100 as shown in FIG. 1, close-up 200 of multi-chiplet system 100 as shown in FIG. 2, and a diagram of a process 400 for verifying an authenticity of a chiplet as shown in FIG. 4.

Referring to FIG. 3, method 300 begins with operation 305, in which the HI system is provided. The HI system can include an interposer and a die coupled to the interposer. The HI system can further include a transmitter die and a receiver die coupled to the interposer. In some embodiments, the HI system can be multi-chiplet system 100, the transmitter die can be TX die 160, the die can be chiplet 150, and the receiver die can be RX die 170, as described with reference to FIGS. 1 and 2.

Referring to FIG. 3, method 300 continues with operation 310, in which a test signal is provided from the transmitter die to the die to perturb the PDN of the HI system. For example, as described with reference to FIG. 2, groups of ROs 262 of TX die 160 can be configured by control unit 264 to provide the test signal to chiplet 150. In some embodiments, the test signal can include a number of components (such as Fourier components) in a spectrum of the test signal, with each component contributed by one of groups of ROs 262.

Referring to FIG. 3, method 300 continues with operation 315, in which response signals are received by the receiver die. The response signals are generated by the PDN of the HI system in response to the test signal passing through the die, and can be used by the receiver die to determine time delays and/or variations of amplitudes between the response signals and the test signal. For example, as described with reference to FIG. 2, TDCs 272 of RX die 170 can receive the response signals, and measure the time delays and/or amplitudes. In some embodiments, each of TDCs 272 can receive a response signal, and the collection of all the response signals received by TDCs 272 can be compiled as a response data 415, as described with reference to FIG. 4.

Referring to FIG. 3, method 300 continues with operation 320, in which the response signals are processed by a machine learning classification algorithm to generate signature data of the die. For example, as described with reference to FIG. 2, processing unit 274 of RX die 170 can perform the machine learning classification algorithm to generate the signature data. In some embodiments, as described with reference to FIG. 4, processing unit 274 can 1) preprocess response data 415 as shown by a block 422 and then 2) analyze response data 415 by the machine learning classification algorithm, such as principal component analysis (PCA) to reduce the dimension of the response data, as shown by a block 424. In some embodiments, preprocessing response data 415 can include averaging response data 415, truncating and/or augmenting response data 415, performing Fourier transformation on response data 415, and/or filtering response data 415.

Analyzing response data 415 by PCA determines the principal components of response data 415. For example, response data 415 can have a number of components corresponding to the components contributed to the test signal by groups of ROs 262. In another example, response data 415 can have a number of components corresponding to the response signals provided by the TDCs 272. In some embodiments, the principal components may not be the individual components contribute by groups of ROs 262 or by TDCs 272, but can be linear combinations of them. Performing PCA on response data 415 can reduce the dimension of response data 415 and extract a small number of most significant components of response data 415. For example, as described with reference to a diagram 426 in FIG. 4, performing PCA on response data 415 can reduce response data 415 down to two-dimensional (2D) determined by a first principal component c₀ along axis 442 (the horizontal axis) and a second principal component c₁ along axis 444 (the vertical axis). In some embodiments, principal components c₀ and c₁ can span a 2D space. In some embodiments, the number of principal components can be different from 2. For example, the number of principal components can be 3, 4, 5, 6, and 7, and the space spanned by the principal components can accordingly be three-dimensional, four-dimensional, five-dimensional, six-dimensional, and seven-dimensional. In some embodiments, the number of principal components can be greater than 7. In some embodiments, after performing PCA on response data 415, response data 415 can be represented by a data point in the space spanned by the principal components. The data point can also be referred to as the signature data. For example, as described with reference to a diagram 426 in FIG. 4, response data 415 can be represented by a signature data 445 in the 2D space spanned by principal components c₀ and c₁.

Referring to FIG. 3, method 300 continues with operation 325, in which the signature data is compared with a reference data representing the authenticity of the die. For example, as described with reference to FIG. 2, the reference data can be stored in storage unit 276 as the standard fingerprint, and processing unit 274 can perform a comparison between the reference data and the signature data. In some embodiments, if a difference between the signature data and the reference data is less than a threshold, the die can be determined as authentic. In some embodiments, if the difference between the signature data and the reference data is greater than the threshold, the die can be determined as compromised. In some embodiments, the reference data can also be represented by a data point in the space spanned by the principal components. For example, as described with reference to FIG. 4, reference data 448 is represented by a data point in the 2D space spanned by principal components c₀ and c₁. In some embodiments, the threshold can be a range enclosing the reference data in the space spanned by the principal components. For example, reference data 448 is enclosed by a range 452 as a threshold, and signature data 446 is within range 452 such that the die can be determined as authentic. In some embodiments, if the PCA performed by processing unit 274 provides another signature data 446′ outside range 452, the die can be determined as compromised. In some embodiments, depending on the specific mechanism about how the die is compromised, a signature data provided by processing unit 274 can fall in different ranges in the space spanned by the principal components. In some embodiments, comparing and the signature data with the reference data can differentiate different dies (e.g., different FPGAs). For example, as described with reference to FIG. 4, if the signature data falls in a range 454 (such as signature data 446′), the die to be tested can be determined as counterfeits/swapped, since the die to be tested and represented by signature data 446′ is distinguishable with the original (authentic) die represented by reference data 448. In some embodiments, comparing and the signature data with the reference data can differentiate different FPGA implementations (e.g., different FPGA builds) in the die to be tested. For example, if the signature data falls in a range 456, the die can be determined as implanted with Trojans, and if the signature data falls in a range 458, the die can be determined as tampered/probed without authorization.

Referring to FIG. 3, method 300 continues with operation 330, in which information about the authenticity of the die is provided. For example, as described with reference to FIG. 2, processing unit 274 can summarize the information about whether chiplet 150 is authentic or compromised and provide a report about the authenticity of chiplet 150. In some embodiments, if chiplet 150 is determined to be compromised, processing unit 274 can further provide detailed information about how chiplet 150 is compromised.

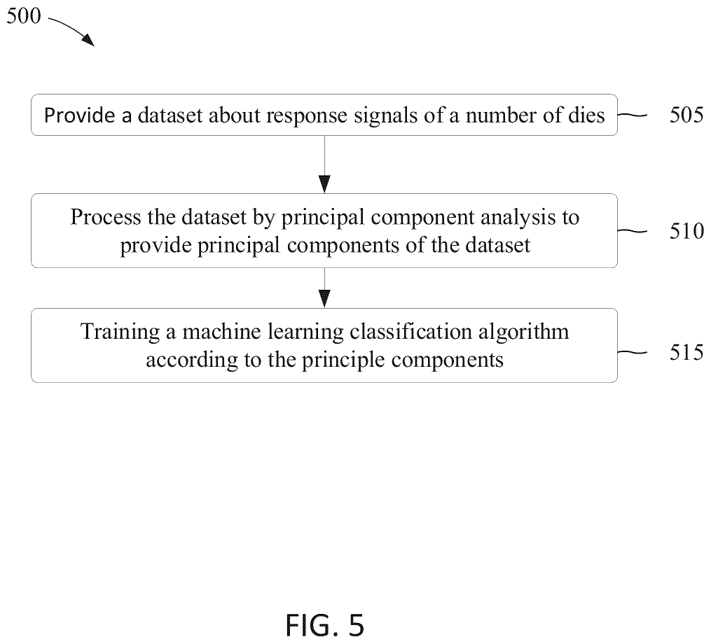

Referring to FIG. 4, as discussed above, diagram 426 illustrates different ranges 452, 454, 456, and 458 in the 2D space spanned by principal components c₀ and c₁. Ranges 452, 454, 456, and 458 correspond to different conditions of authenticity of the die, which can be predetermined by training the machine learning classification algorithm using a dataset about a number of dies with different conditions of authenticity. FIG. 5 illustrates a flowchart about a method 500 for training the machine learning classification algorithm. This disclosure is not limited to this operational description and additional operations may be performed. Other operations can be performed between the various operations of method 500 and are omitted merely for clarity. Moreover, not all operations may be needed to perform the disclosure provided herein. Additionally, some of the operations may be performed simultaneously, or in a different order than the ones shown in FIG. 5. In some embodiments, one or more other operations may be performed in addition to or in place of the presently described operations. For illustrative purposes, method 500 is described with reference to FIGS. 1-4.

Referring to FIG. 5, method 500 begins with operation 505, in which a dataset about response signals of a plurality of dies is provided. In some embodiments, the response signals can be provided in response to test signals. For example, as shown with reference to FIGS. 1 and 2, TX die 160 can send test signals to each of chiplets 150 in multi-chiplet system 100, and RX die 170 can measure the response signals accordingly. In some embodiments, method 300 as shown in FIG. 3 can be used to provide the response signals for each of chiplets 150 in multi-chiplet system 100. These response signals can be collected to form the dataset.

In some embodiments, the plurality of dies can be chiplets in a single multi-chiplet system. In some embodiments, the plurality of dies can include chiplets from different multi-chiplet systems. In some embodiments, the plurality of dies can be divided into different categories. For example, the plurality of dies can include a group of authentic dies and a group of compromised dies. In some embodiments, the group of compromised dies can further be divided into subgroups according to the specific mechanisms that the dies are compromised.

In some embodiments, the plurality of dies can include different types of FPGAs. In some embodiments, the plurality of dies can include the same type of FPGA but with different FPGA builds. In some embodiments, the compromised dies can be prepared by introducing different types of noise into the FPGAs.

Referring to FIG. 5, method 500 continues with operation 510, in which the dataset is processed by PCA to provide principal components of the response signals in the dataset. In some embodiments, prior to the PCA, the response signals in the dataset can be preprocessed, for example, by processing unit 274 as shown in FIG. 2. For example, the response signals in the dataset can be averaged, truncated, augmented, filtered, and/or transformed between time and frequency domains. In some embodiments, performing the PCA on the response signals in the dataset can include performing singular value decomposition on the response signals in the dataset to calculate a number of singular values and their associated singular vectors. Among the singular vectors, the principal components can be chosen as those whose singular values have dominant amplitudes. In some embodiments, the dataset can include a set of training data and a set of testing data. The set of training data can be used in subsequent operation 515 to train a machine learning classification algorithm, and the set of testing data can be used to test a performance of the machine learning classification algorithm.

Referring to FIG. 5, method 500 continues with operation 515, in which the machine learning classification algorithm can be trained in a training process according to the principal components of the response signals in the dataset. In some embodiments, parameters of the machine learning classification algorithm can be tuned during the training process to optimize an efficacy of clustering the response signals in the space spanned by the principal components, according to the categories of the response signals. In some embodiments, training the machine learning classification algorithm can include determining a range of authentic dies in the space spanned by the principal components, such as range 452, as shown in FIG. 4. In some embodiments, training the machine learning classification algorithm can include determining ranges of compromised dies in the space spanned by the principal components, such as ranges 454, 456, and 458, as shown in FIG. 4.

In some embodiments, after performing PCA in operation 510, the machine learning classification algorithm can be trained in operation 515 to effectively distinguish dies as being authentic or compromised. In some embodiments, instead of performing PCA in operation 510, each of the response signals in the dataset can be analyzed by a Mahalanobis-based method. For example, Mahalanobis distances of the response signals in the dataset can be calculated and then be used to train the machine learning classification algorithm to effectively distinguish dies being authentic or compromised. In some embodiments, instead of performing PCA in operation 510, each of the response signals in the dataset can be analyzed by taking its average. The averages of the response signals in the dataset can then be used to train the machine learning classification algorithm to effectively distinguish dies being authentic or compromised. In some embodiments, taking the Mahalanobis distances or the averages of the response signals in the dataset can be resource-efficient. For example, the training process in operation 515 can be faster, and processing unit 274 in RX die 170 can have simple, compact, and efficient hardware configurations.

In some embodiments, after training process, the machine learning classification algorithm can be tested by the set of testing data to evaluate the performance of the machine learning classification algorithm. In some embodiments, a report about the training process can be provided at the end of operation 515. The report can include information about the performance of the trained machine learning classification algorithm, such as a precision of the machine learning classification algorithm applied on the set of testing data.

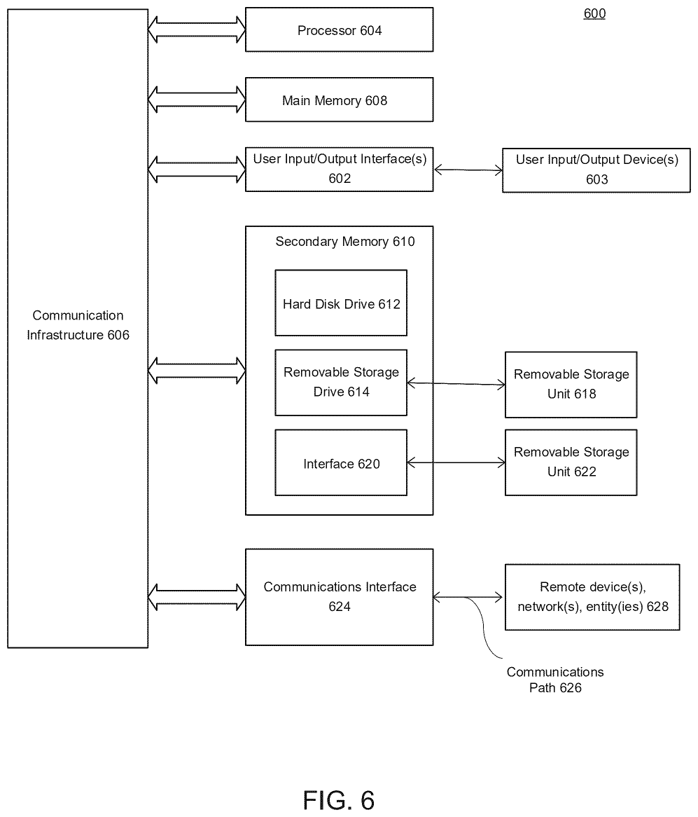

Various embodiments may be implemented, for example, using one or more well-known computer systems, such as computer system 600 shown in FIG. 6. For example, multi-chiplet system 100 as shown in FIG. 1, method 300 as shown in FIG. 3, and method 500 as shown in FIG. 5 may be implemented using combinations or sub-combinations of computer system 600. Also or alternatively, one or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 600 may farther include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereat), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions): “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600 or processor(s) 604), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all possible embodiments of the present disclosure as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above described exemplary embodiments, but should be defined only in accordance with the following claims and their equivalents.

What is claimed is:

1. A device, comprising:
a substrate comprising an interposer;
a first die on the substrate and coupled to the interposer;
a second die on the substrate and coupled to the interposer, wherein the second die is configured to provide a test signal to the first die to generate a perturbation in a power distribution network (PDN) of the device; and
a third die on the substrate and coupled to the interposer, wherein the third die is configured to:
receive a response signal in response to the the perturbation in the PDN;
determine, according to the response signal, an authenticity of the first die based on a machine learning classification algorithm; and
provide a signal indicating the authenticity of the first die.

2. The device of claim 1, wherein the second die comprises a plurality of ring oscillators configured to provide the test signal.

3. The device of claim 2, wherein a quantity of the plurality of ring oscillators is between about 5,000 and about 20,000.

4. The device of claim 1, wherein the third die comprises a plurality of time-to-digital converters configured to measure time delays and/or amplitudes between the test signal and the respond signals.

5. The device of claim 4, wherein a quantity of the plurality of time-to-digital converters is between about 3 and about 10.

6. The device of claim 1, wherein the third die comprises a memory configured to store a reference data representing an authentic condition of the first die.

7. The device of claim 6, wherein the third die is further configured to provide a signature data of the first die according to the respond signals and determine a difference between the signature data and the reference data.

8. The device of claim 7, wherein the third die is further configured to:
in response to the difference greater than a threshold, provide a first signal indicating that the first die is compromised; and
in response to the difference less the threshold, provide a second signal indicating that the first die is authentic.

9. The device of claim 1, wherein the machine learning classification algorithm comprises a principal component analysis algorithm.

10. A system, comprising:
a plurality of dies coupled to an interposer;
a transmitter die coupled to the interposer and configured to provide testing signals to one or more of the plurality of dies; and
a receiver die coupled to the interposer and configured to:
receive response signals in response to a perturbation of a power distribution network (PDN) of the system by the test signals; and
provide an information about an authenticity of the plurality of dies by processing the response signals using a machine learning classification algorithm.

11. The system of claim 10, wherein the transmitter die comprises a plurality of ring oscillators configured to provide the testing signals.

12. The system of claim 10, wherein the receiver die comprises a plurality of time-to-digital converters configured to measure time delays and/or amplitudes of the response signals with respect to the testing signals.

13. The system of claim 10, wherein the machine learning classification algorithm is trained by data about authenticity conditions of a plurality of authentic dies and a plurality of compromised dies.

14. The system of claim 10, wherein the machine learning classification algorithm comprises a principal component analysis algorithm.

15. A method, comprising:
providing a heterogeneous integration (HI) system comprising a die, a transmitter die, and a receiver die on a substrate;
providing, by the transmitter die, a test signal to the die via the substrate;
receiving, by the receiver die, response signals in response to a perturbation of a power distribution network (PDN) of the HI system by the test signal;
processing the response signals by a machine learning classification algorithm to generate a signature data;
comparing the signature data to a reference data representing an authentic condition of the die; and
providing an information about the authenticity of the die based on a result of comparing the signature data to the reference data.

16. The method of claim 15, wherein:
the reference data is generated by the machine learning classification algorithm; and
the reference data is stored in the transmitter die at a final manufacturing stage of the HI system.

17. The method of claim 15, wherein the machine learning classification algorithm is trained by classifying a plurality of authentic dies and a plurality of compromised dies using principal component analysis.

18. The method of claim 15, wherein providing the test signal comprises configuring a plurality of ring oscillators in the transmitter die to generate the test signal.

19. The method of claim 15, wherein receiving the response signal comprises measuring time delays and/or amplitudes of the response signals by a plurality of time-to-digital converters on the receiver die.

20. The method of claim 15, wherein providing an information about the authenticity of the die comprises determining a mechanism about how the die is compromised.
